(19) United States
(12) Patent Application Publication
(10) Pub. No.: US 2026/0050785 A1
(43) Pub. Date: Feb. 19, 2026

(54) TRAINING A TARGET ACTIVATION SPARSITY IN A NEURAL NETWORK

(71) Applicant: Salesforce, Inc., San Francisco, CA (US)

(72) Inventors: Damjan Kalajdzievski, Los Altos, CA (US); Romain Cosentino, Los Altos, CA (US); Sarath Shekkizhar, Los Altos, CA (US)

(73) Assignee: Salesforce, Inc., San Francisco, CA (US)

(21) Appl. No.: 18/802,235

(22) Filed: Aug. 13, 2024

(51) Int. Cl. G06N 3/082; G06N 3/048

(52) U.S. Cl. CPC G06N 3/082; G06N 3/048

(57) ABSTRACT

Techniques are described herein for a method of training a target activation sparsity in a neural network. The method includes obtaining a nonlinear portion of a plurality of neurons in a neural network. The neural network is trained to perform a target task. The method further includes substituting the nonlinear portion for a dynamic nonlinear portion in the plurality of neurons in the neural network. The dynamic nonlinear portion is trained to activate or deactivate one or more neurons of the plurality of neurons. The method further includes retraining the neural network using a first loss function that minimizes a loss of the target task and a second loss function that minimizes a number of active neurons.

### BACKGROUND

The field of Artificial Intelligence (AI) focuses on the implementation of artificial neural network systems that aim to mimic the functionality of neurons in the brain. Machine learning is a sub-area of AI in which a machine learning model is trained to perform one or more specific tasks. For instance, a machine learning model can be trained to perform a target task by relying on patterns and inferences learned from training data, without requiring explicit instructions pertaining to how the task is to be performed.

### SUMMARY

Techniques are described herein for a method of training a target activation sparsity in a neural network. The method includes obtaining a nonlinear portion of a plurality of neurons in a neural network. The neural network is trained to perform a target task. The method further includes substituting the nonlinear portion for a dynamic nonlinear portion in the plurality of neurons in the neural network. The dynamic nonlinear portion is trained to activate or deactivate one or more neurons in the plurality of neurons. The method further includes retraining the neural network using a first loss function that minimizes a loss of the target task and a second loss function that minimizes a number of active neurons.

### BRIEF DESCRIPTION OF THE DRAWINGS

The detailed description is described with reference to the accompanying drawings in which:

FIG. 1 illustrates a sparsification system, in accordance with one or more embodiments;

FIG. 2 illustrates an example architecture of a neural network, in accordance with some embodiments of the present disclosure;

FIG. 3 illustrates an example method for training a neural network model using supervised learning, in accordance with some embodiments of the present disclosure;

FIG. 4 illustrates an example deployment of a sparse machine learning model, in accordance with one or more embodiments;

FIG. 5 illustrates a flowchart of a series of acts in a method of training a target activation sparsity in a neural network, in accordance with one or more embodiments;

FIG. 6 illustrates a schematic diagram of an environment in which the sparsification system can operate in accordance with one or more embodiments; and

FIG. 7 illustrates a block diagram of an example computing device, in accordance with one or more embodiments.

### DETAILED DESCRIPTION

One or more embodiments of the present disclosure include a sparsification system used to sparsify a neural network by deactivating a target number of neurons in the neural network. Sparsifying a machine learning model such as a neural network is used to conserve computing resources. For example, sparsifying a model can reduce computing resources associated with processing an input by zeroing entries in a vector. Propagating zero entries through layers of a neural network can conserve computing resources by reducing the number of mathematical operations performed and reducing the latency associated with generating an output. Additionally, zero entries can conserve computing resources such as memory because only non-zero entries are fetched from memory. Accordingly, increasing the number of zero entries of the network corresponds to fewer non-zero entries being stored in and/or being fetched from memory of a computing device implementing the neural network.

Additionally, sparsifying a neural network can improve model interpretability, as only important features of the input are non-zeroed. Further, sparsifying the neural network can regularize the neural network. Model regularization is a mechanism for discouraging overfitting in a neural network by reducing the ability of the neural network to capture an overly complicated relationship of the data. Overfitting the neural network causes an increase in performance on training data and a decrease in performance during inference because the relationships captured during training using the training data are overly complicated such that the relationships poorly capture the relationships of new data (e.g., data during an inference period).

A neural network is trained to perform a target task such as a natural language processing task (e.g., text generation, text summarization, language translation), an image processing task (e.g., object tracking, object classification), or an audio processing task (e.g., speaker recognition, speaker verification). Neural networks perform target tasks using layers that include neurons, which are interconnected using weights (e.g., weight representations including weight matrices, weight vectors, and the like). The neurons are interconnected to neurons of other layers (e.g., adjacent layers). Neurons sum up values received from interconnected neurons and apply an activation function to map the received values to a different space such that nonlinear patterns can be captured by the neurons. Capturing nonlinear patterns of the input data allows the neural network model to perform the target task. During a training period, the values of the weights interconnecting each neuron are adjusted based on the error, as described below.

Machine learning models such as neural networks can be limited by the computational resources of devices implementing the neural network. For example, processing a large input (e.g., a high-resolution image, lengthy natural language text, etc.) can consume significant computing resources due to all of the mathematical operations being performed by neurons in layers of the neural network.

Machine learning engineers or other data scientists weigh the tradeoff between the size of the neural network (which translates to the time and computational resources required to implement the neural network) and the accuracy of performing a target task. When designing the neural network, machine learning engineers make various design choices that affect the size of the neural network and the accuracy of the neural network in performing the task. For example, machine learning engineers determine the architecture of the machine learning model (e.g., convolutional neural networks, transformers, recurrent neural networks), the number of layers of the machine learning model, the number of neurons in each layer of the machine learning model, the activation function used by neurons of the machine learning model, and the like.

As described herein, activation functions are nonlinear functions that map the preactivation of a neuron to an output activation. In operation, the output of the neuron (e.g., the preactivation) is mapped to another output (e.g., an activation). The activation function enables a neuron to represent a nonlinear function, and nonlinearities in a neural network are used to learn complex patterns. Accordingly, the activation functions enable the neural network to simulate any smooth function applied to the input of the neural network. For example, activation functions can map a preactivation to a small value such as zero or near zero. Given this type of mapping, the neuron is effectively turned “off,” or inactive, with respect to the particular preactivation.

The input to the activation function is referred to as the preactivation, and is described in more detail herein. Additionally, there can be a probabilistic interpretation associated with the set of values output by the activation function. For example, the activation function can be used to determine the likelihood of an output preactivation being turned off (e.g., the preactivation is a small value such as zero). Accordingly, the strength of the preactivation (e.g., the magnitude) is used to determine the likelihood of the activation function turning off a neuron. Accordingly, the activation function that models the distributional assumptions on the preactivation input to the neuron is a random variable.

One conventional sparsification method is to select ReLU as an activation function because ReLU is a simple ramp function that zeroes any input value that is negative. In other words, neurons in the neural network that receive a negative preactivation are deactivated (e.g., turned off). Turning off neurons reduces computing resources associated with an input because fewer computations are performed. However, sparsifying a neural network by replacing the activation functions of a trained model with ReLU can affect the performance of the trained neural network model. As a result, the neural network model with ReLU substitutions is retrained, which can consume significant computing resources. Additionally, even with retraining, the sparse neural network model with substituted ReLU activations may not achieve the same accuracy as the non-sparse neural network model. For example, some neural networks may be incompatible with a ReLU activation substitution. Lastly, substituting ReLU as the activation function does not provide any control over the number of active neurons. For example, sparsifying the neural network by replacing the activation functions with ReLU does not necessarily achieve a target level of sparsity. That is, a machine learning engineer cannot specify a target number of sparse neurons in each layer.

Other conventional systems sparsify a neural network by partitioning the neural network into blocks (e.g., blocks of layers, blocks of neurons, etc.). Such systems then determine whether to activate (e.g., turn on) a partitioned block given an input, and other blocks are inactive (e.g., turned off). However, such systems are limited to activating or deactivating neurons of particular blocks.

To address these and other deficiencies of conventional approaches, the sparsification system of the present disclosure substitutes the existing random variable of activations (e.g., the activation function) of a neural network with a learnable nonlinearity. The sparsification system can achieve a target activation sparsity in the neural network by learning to deactivate a target number of neurons in the neural network using the learnable nonlinearity. Additionally, the learnable nonlinearity can be derived from the statistical modeling characteristics of the underlying activations of the neural network model (e.g., the non-sparse neural network model) and/or based on the underlying preactivations of the neural network model. Basing the learnable nonlinearity on the underlying preactivations of the neural network reduces changes to the underlying preactivations during the sparsification process. As a result, the performance of the sparse neural network is at least as good as the non-sparse pretrained neural network. This is in contrast to conventional systems that replace each neuron of a neural network with a nonlinear activation (such as ReLU), as described above. As described herein, replacing the nonlinear activations of the pretrained neural network with the learnable nonlinearity transforms the pretrained neural network into a sparse neural network.

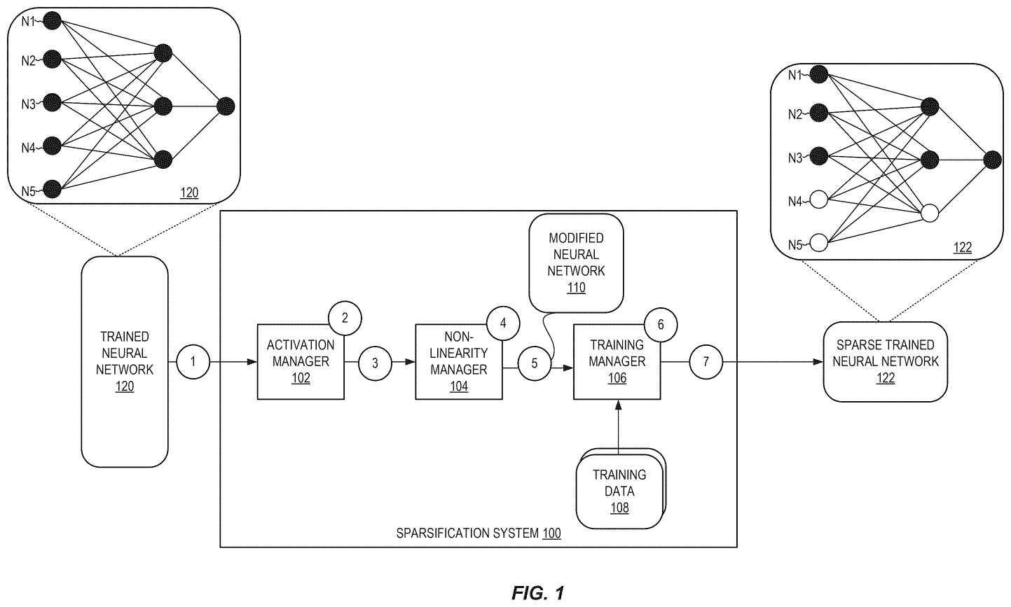

FIG. 1 illustrates an example sparsification system, in accordance with one or more embodiments. In some embodiments, the sparsification system 100 may be incorporated into an application, a suite of applications, etc. or may be implemented as a standalone system which interfaces with an application, a suite of applications, etc. The sparsification system 100 is used to sparsify the trained neural network 120 (e.g., a pretrained non-sparse model) such that the sparse trained neural network 122 achieves at least a non-sparse level of performance on a downstream task. That is, the performance of the sparse trained neural network 122 meets or exceeds a threshold performance set by the trained neural network 120 in performing the task for which the neural network model 120 was trained. The sparsification system 100 modifies trained neural network 120 to achieve a target activation sparsity of the neural network (e.g., sparse. trained neural network 122). As shown in FIG. 1, the trained neural network 120 is a fully connected neural network, however any neural network model can be made sparse using the sparsification system 100

At numeral 1, the activation manager 102 receives a trained neural network 120. The trained neural network 120 is any neural network that is trained to perform a task (e.g., convolution, natural language understanding, classification, image processing). While the sparsification system 100 is illustrated as receiving a trained neural network 120, in some embodiments, the sparsification system 100 trains a neural network model using training data 108 to obtain trained neural network 120 (not shown).

Each of the neurons in the trained neural network 120 are active, as indicated by black circles of the neural network 120. As described herein, an active neuron is a neuron that contributes to the output of the trained neural network 120. In other words, an active neuron produces an output that meets or exceeds a threshold (e.g., 0). An inactive neuron is a neuron that does not contribute to the output of the trained neural network 120. In other words, the inactive neuron produces an output that does not meet or exceed the threshold (e.g., the neuron output is zero). For example, an inactive neuron, represented mathematically as a vector, includes zero entries in the vector such that multiplication using the vector (e.g., the inactive neuron vector) produces zero values. These zero values are propagated through the neural network, reducing computations associated with other neurons in other layers of the neural network model. The propagation of such zero values, as a result of inactive neurons, reduces the time for the neural network to produce an output and minimizes computing resources because multiplication involving zero values is quick and simple. Additionally, the inactive neuron vector (being a vector of zeroes) reduces the memory associated with storing the neuron vector. As a result, the size of the neural network decreases based on the number of inactive neurons in the network (e.g., a sparse neural network is smaller than a non-sparse neural network).

At numeral 2, the activation manager obtains the nonlinear activations of the trained neural network 120. In some embodiments, the activation manager obtains the nonlinear activations of the trained neural network 120 by determining a statistical representation of the distribution of preactivations that represents the nonlinear portion of neurons in the trained neural network 120. For example, the activation manager 102 can compute the mean and standard deviation of the distribution of the preactivations for each neuron to determine a statistical model of the nonlinear portion for each neuron (e.g., CDF_{nonlinear portion}). For example, given a mean and standard deviation of a family of statistical distributions that can be defined by the mean and standard deviation (e.g., the Gaussian distribution or the logistic distribution), the mean and standard deviation of the preactivations, substituted as the mean and standard deviation of the nonlinear portion, can be used as a proxy for the statistical distribution of the preactivation for a neuron. In some embodiments, neurons in a layer are assumed to be independent and identically distributed such that computing the mean and standard deviation of the distribution of the preactivations for a single neuron in a layer can be used to determine the statistical model of the nonlinear portion of each neuron in the layer. In other embodiments neurons in a layer are not independent and identically distributed. For example, the activation manager 102 can statistically represent the nonlinear portion of neurons in the layer differently for different distributional assumptions on the preactivation x.

In some embodiments, the activation manager obtains the nonlinear activations of the trained neural network 120 by receiving, as an input, the nonlinear portion of each neuron in the neural network model. For example, the activation manager 102 can receive the nonlinear portion for one or more neurons of the trained neural network 120 from a user such as a machine learning engineer. Accordingly, the activation manager 102 can statistically represent the nonlinear portion of each neuron using the distributional assumptions on the preactivation x (e.g., CDF_{X}(x)).

In some embodiments, the nonlinear portion of each neuron in a layer is the same. That is, the neurons in the layer are independent and identically distributed. As a result, the activation manager 102 can statistically represent the nonlinear portion of each neuron in the layer using the distributional assumptions on the preactivation x. In other embodiments neurons in a layer are not independent and identically distributed. For example, the activation manager 102 can statistically represent the nonlinear portion of neurons in the layer differently for different distributional assumptions on the preactivation x.

As described herein, nonlinear activations can include nonlinear activation functions that map the input (e.g., preactivations) to a nonlinear output, representing the strength of a particular neuron in the neural network. For ease of description, a nonlinear activation of a neuron (e.g., a preactivation distribution of the neuron) is referred to herein as nonlinear portion of a neuron. Common nonlinear portions include the rectified linear unit (ReLU), the Gaussian error linear unit (GELU), and the sigmoid-weighted linear unit (SiLU), mathematically represented in Equation (1) below:

$$Re LU ( x ) = ( x , 0 ) \qquad ( 1 )$$

$$GELU ( x ) = \frac{x}{2} ( 1 + ( \frac{x}{\sqrt{2}} ) ) , where = \frac{2}{\sqrt{π}} {\int }_{0}^{x} {e}^{- {t}^{2}} dt$$

$$SiLU ( x ) = \frac{1}{1 + {e}^{- x}}$$

The common nonlinear portions illustrated in Equation (1) above can be represented using statistics as shown in Equation (2) below:

$$Re LU ( x ) = x ⊙ ( 1 - {CDF}_{{δ}_{0}} ( x ) ) \qquad ( 2 )$$

$$GELU ( x ) = x ⊙ {CDF}_{N ( 0 , 1 )} ( x )$$

$$SiLU ( x ) = x ⊙ {CDF}_{Logistic ( 0 , 1 )} ( x )$$

In Equation (2) above, CDF is the cumulative distribution function, δ₀ represents a unit impulse centered at zero, N(0,1) represents a normal distribution (e.g., a Gaussian distribution) with a mean of 0 and a standard deviation of 1, Logistic(0,1) represents the logistic function with a mean of 0 and a standard deviation of 1, and the operation ⊙ represents pointwise multiplication of the preactivation x and the statistical representation of the nonlinear portion. In general, some nonlinear portion of a neuron can be statistically represented according to Equation (3) below:

$$f ( x ) = x ⊙ {CDF}_{X} ( x ) \qquad ( 3 )$$

In Equation (3) above, the CDF_{X} represents the cumulative distribution function of the nonlinear portion (e.g., X) given the set of possible values of the preactivations (e.g., x). As the preactivations increase, the likelihood that the nonlinear portion will be less than the preactivation increases. In other words for the above probabilistic interpretation, as the preactivation increases, there is a higher probability of turning on the neuron.

At numeral 3, the activation manager 102 passes information related to the nonlinear portion of the trained neural network 120 to the nonlinearity manager 104. For example, the activation manager 102 passes information such as the nonlinear portion of the trained neural network 120, and whether the neurons in the trained neural network 120 are independent and identically distributed (e.g., all of the neurons in the trained neural network 120 have the same nonlinear portion), whether the neurons in a layer of the trained neural network 120 are independent and identically distributed (e.g., all of the neurons in a layer in the trained neural network 120 have the same nonlinear portion), or whether each neuron has a unique nonlinear portion, determined by the activation manager 102.

At numeral 4, the nonlinearity manager 104 substitutes or otherwise replaces the nonlinear portion of neurons of the trained neural network 120 with a learnable nonlinearity, the order statistic gated linear unit (osXLU). Order statistics is the arrangement of the values in order of magnitude. For example, given a nonlinear portion with n samples in the preactivation distribution, the (n−k)^{th} order statistic is the nonlinear portion X₍ₙ₋ₖ₎ which represents the (n−k)^{th} smallest value of the n samples from the nonlinear portion. Substituting osXLU in one or more neurons of the trained neural network 120 is used to obtain the probability of any entry x of the preactivation distribution being the top-k largest activation. In other words, neurons can be ranked according to the ordered activation such that top-k neurons corresponding to the top-k activations are expected to be activated. That is, on average, the top-k neurons are activated. Accordingly, neurons associated with activations that are not the top-k activations are expected to be deactivated by zeroing entries of the neuron vector. That is, on average, the neurons associated with activations that are not the top-k activations are deactivated.

OsXLU represents a family of learnable nonlinearities that is used to sparsify the activations of the neural network. In operation, osXLU exhibits a specified or learnable level of sparsity in expectation over the preactivations. In other words, osXLU is used to turn off a target number of neurons of the trained neural network 120. Specifically, OsXLU is trained such that a number k of neurons is set to non-zero on average. The k neurons that are activated are the k most relevant neurons (e.g., the top k neurons, based on the order statistic of the underlying nonlinear portion). In some embodiments, the nonlinearity manager 104 receives the number k of nonzero activations from a user such as a machine learning engineer.

The probability of any preactivation value being in the top k largest activation is represented statistically using osXLU in Equation (4) below:

$$1 - {CDF}_{{X}_{n - k}} ( x ) = {\sum }_{i = n - k}^{n} ( \frac{n}{i} ) {( {CDX}_{X} ( x ) )}^{i} {( 1 - {CDF}_{X} ( x ) )}^{n - i} \qquad ( 4 )$$

$$where ( \frac{n}{i} ) = \frac{n !}{k ! ( n - i ) !}$$

Applying osXLU (referred to herein as a dynamic nonlinear portion) to preactivations x given an underlying nonlinear portion X is mathematically represented according to Equation (5) below:

$$osXLU ( x ) = x ⊙ {\sum }_{i = n - k}^{n} ( \frac{n}{i} ) {( {CDX}_{X} ( x ) )}^{i} {( 1 - {CDF}_{X} ( x ) )}^{n - i} \qquad ( 5 )$$

The nonlinear portion X is the information received by the nonlinearity manager 104 from the activation manager 102 at numeral 3. In other words, the dynamic nonlinear portion (e.g., OsXLU) is derived from the statistical modeling characteristics of the underlying activations of the trained neural network 120. In a non-limiting example, given a nonlinear portion of the trained neural network 120, GELU, the osXLU replacing the GELU would be osGELU where X=N(0,1) or more generally N(μ, σ), where μ represents the mean and σ represents the standard deviation. Similarly, given the nonlinear portion of the trained neural network 120, SiLU, the osXLU replacing the SiLU would be osSILU where X=Logistic (0,1) or more generally Logistic(μ, σ).

The nonlinearity manager 104 can make osXLU differentiable by replacing the binomial coefficients

$$( \frac{n}{i} )$$

in Equation (3) above with the Gamma function extension of the factorial

$$\frac{Γ ( n + 1 )}{( ( Γ ( n - i + 1 ) Γ ( i + 1 ) )}$$

where Γ(n)=(n−1)! Additionally or alternatively, the nonlinearity manager 104 can make osXLU differentiable with respect to k using the Gaussian approximation to the Binomial CDF, as shown in Equation (6) below:

$$1 - {CDF}_{{X}_{n - k}} ( x ) = {\sum }_{i = n - k}^{n} ( \frac{n}{i} ) ( {{CDX}_{X} ( x )}^{i} {( 1 - {CDF}_{X} ( x ) )}^{n - i} \qquad ( 6 )$$

$$\approx 1 - {CDF}_{N ( 0 , 1 )} ( \frac{n - k - {nCDF}_{x} ( x )}{\sqrt{{nCDF}_{X} ( x ) ( 1 - {CDX}_{X} ( x ) )}} )$$

The mean and standard deviation of the Gaussian distribution (e.g., N(μ, σ)) can be received as part of information related to the nonlinear portion of the trained neural network 120 from the activation manager 102 at numeral 3. In other words, the dynamic nonlinear portion (e.g., osXLU) is informed by the statistics of the preactivations.

It should be appreciated that while a single learnable nonlinearity is described (e.g., the dynamic nonlinear portion osXLU), in some embodiments, the dynamic nonlinear portion that substitutes the nonlinear portion can be a combination of one or more nonlinearities that represent the underlying preactivations. For example, the dynamic nonlinear portion can be defined using a combination of one or more functions to obtain a behavior that is similar to that of the underlying preactivations. In operation, the dynamic nonlinear portion uses order statistics of any combination of one or more functions that are a proxy of the underlying preactivations to obtain a target activation sparsity.

At numeral 5, the nonlinearity manager passes the trained neural network with dynamic nonlinear portions substituting the nonlinear portions of the trained neural network (referred to herein as modified neural network 110) to the training manager 106. At numeral 6, the training manager 106 receives the modified neural network 110. After training, the modified neural network model becomes the sparse trained neural network 122.

The training manager 106 trains the modified neural network 110 to perform the task for which the trained neural network 120 was trained using any suitable mechanism. For example, the training manager 106 may train the modified neural network 110 using supervised learning and one or more sets of training data 108.

Additionally, the training manager 106 trains neurons in the modified neural network 110 to activate or deactivate using the dynamic nonlinear portion of the neurons. Accordingly, the training manager 106 optimizes the number of inactive neurons in the modified neural network 110 by balancing a sparsification loss and a task loss.

In some embodiments, the training data 108 can include a general training dataset. For example, if the trained neural network 120 is a large language model trained to perform natural language understanding tasks, training data 108 can include a general natural language training dataset used to confirm that the sparse trained neural network 122 can perform natural language understandings tasks at least at the same accuracy as the accuracy of the trained neural network 120 in performing natural language understanding tasks.

Training data 108 can also include training data used to train the trained neural network 120 to perform a target task. In some implementations, the training data used to train the trained neural network 120 is used during training of the modified neural network 110. As a result, the sparse trained neural network 122 can perform the same target task as the trained neural network 120 at least at the same accuracy as the accuracy of the trained neural network 120 in performing the target task.

At numeral 7, the sparse trained neural network 122 is output from the sparsification system. The sparse trained neural network 122 includes an average of k number of active neurons, making the sparse trained neural network 122 sparse when compared to the trained neural network 120. Inactive neurons are indicated in the sparse trained neural network 122 as white circles. Additionally, the sparse trained neural network 122 can perform the task of the trained neural network 120 at least as well as the trained neural network 120. That is, the performance of the sparse trained neural network 122 meets or exceeds a threshold performance set by the trained neural network 120 in performing the task.

The sparsification system 100 is also configured to store data utilized during the execution of the sparsification system 100. For example, the sparsification system 100 can store thresholds, neurons, random variables, statistics (such as means, variances, standard deviation associated with one or more neurons in a layer), training data 108, and the like.

In some implementations, the sparsification system 100 hosts the one or more modules of the sparsification system 100 (e.g., activation manager 102, the nonlinearity manager 104, and/or the training manager 106). In these implementations, the sparsification system 100 executes local processors/memory to perform one or more functions of the one or more modules. In other implementations, the sparsification system 100 remotely accesses the one or more modules. For example, the sparsification system 100 may call one or more servers, processors, etc. hosted in a cloud computing environment. In these implementations, the sparsification system 100 calls one or more other systems, processors, service providers, etc., to perform one or more functions of the modules of the sparsification system 100.

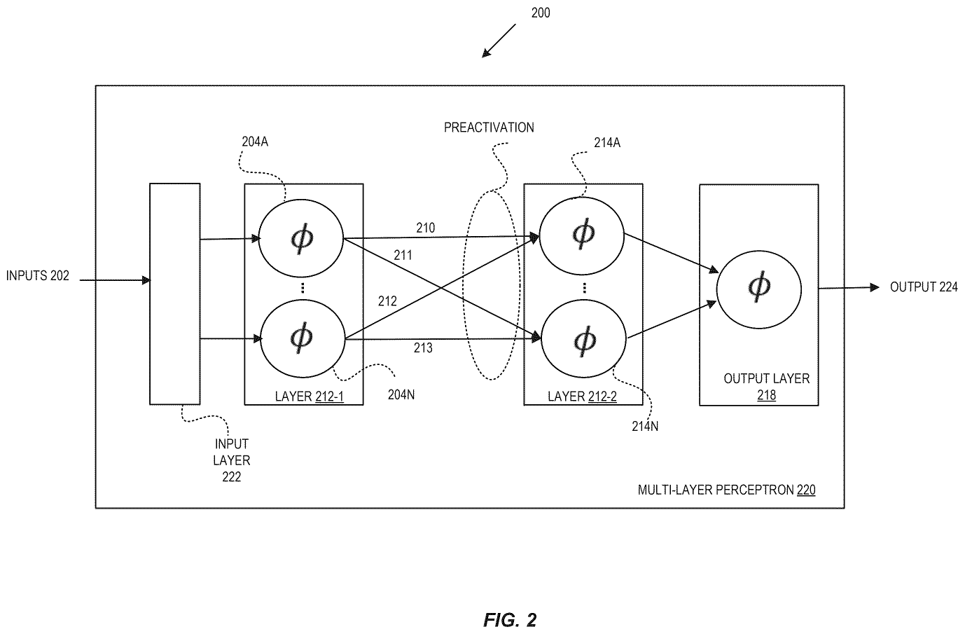

FIG. 2 illustrates an example architecture of a neural network, in accordance with some embodiments of the present disclosure. The example 200 illustrates a multi-layer perceptron (MLP) which includes a fully connected architecture. MLPs are neural network architectures that can be implemented in other neural network models such as the large language model. For example, a transformer machine learning model (e.g., a large language model) uses MLPs to perform natural language understanding tasks. Sparsifying neurons of a MLP that are implemented in a large language model such as a transformer can reduce the computing resources associated with large language models, time required to generate an output determined by the large language model, and the like.

As illustrated, the MLP 220 includes layers (vertically oriented) that receive an input 202 between an input layer 222 and an output layer 218. The input layer 222 can perform some processing of the input 202 such as padding the input 202 and/or normalizing the input 202. The output layer 218 receives an input from each of the nodes of the adjacent layer (e.g., neurons 214A-214N of layer 212-2) to determine an output 224. For ease of description, other nodes, layers, and connections are not shown.

Layers allow the MLP 220 to perform sub-tasks associated with learning a particular task. For example, a layer, such as 212-1 or 212-2, may perform a convolutional sub-task and/or a pooling sub-task. Other tasks that can be performed by layers of a neural network include an encoding sub-task, a decoding sub-task, and an attention sub-task, for instance. The sub-tasks of the MLP 220 transform the input 202 into a latent space representation in which unobserved features are determined such that the relationship and other dependencies of such features can be learned.

Layers include neurons, illustrated as nodes 204A-204N and 214A-214N respectively for layers 212-1 and 212-2. Each neuron includes an activation function (represented visually as phi in MLP 220) which is a nonlinear function that maps the input of the neuron to the latent space representation to better capture complex relationships of the input 202. As described herein, phi can include activation functions such as ReLU, GELU, SiLU, to name a few.

The output of the neurons of layer 212-1 are passed to the next layer, layer 212-2 using weights 210-213. Each weight 210-213 is a weight representation w (e.g., a weight tensor, a weight matrix, or a weight vector, etc.) of the set weights included in a weight tensor W. In some embodiments, W E R xd and each weight 210-213 is a weight vector w. The dimension/represents the number of neurons in the layer, i.e., the output dimension of the layer, and dimension d represents the input dimension. For example, in the first layer of the MLP 220, the input dimension d is the dimension of the number of inputs 202 fed to the neural network. The weight tensor W is a collection of weight representations (e.g., 210-213) in a layer in the network.

Weights can capture the complex relationships of the input 202 by controlling the strength of the connected neurons. The values of the weights are tuned during a training period including a number of iterations. For example, gradient descent algorithms can be used to minimize a loss function over a number of iterations. In operation, the error associated with performing the target task decreases over a number of iterations of the training period, and the gradient of the weights with respect to the loss function is used to proportionally adjust the weights. As illustrated in Equation (7) below, the weight representation w associated with each neuron changes.:

$${w}_{i} ( n + 1 ) = {w}_{i} ( n ) - γ ∇ {w}_{i} \qquad ( 7 )$$

$${w}_{i} = \frac{\partial ε ( n )}{\partial {w}_{i}} = ∇ {neuron}_{i}$$

$$Where$$

$$∇ W = \begin{matrix}∇ {n}_{1} \\ ∇ {n}_{2} \\ ∇ {n}_{3}\end{matrix}$$

In Equation (7) above, weight wᵢ represents the weight connected to the i′th neuron, W represents the weight tensor of weights in a layer of the MLP 220, γ represents the learning rate, and ε(n) represents the loss function used to determine the error at iteration n. Any continuous and differentiable function can be optimized as the loss function ε using stochastic gradient descent. The training period ends when the error associated with performing the target task satisfies an acceptability threshold and/or confidence threshold, a number of training iterations have been performed, a duration of time has been satisfied, or the like.

The input to the neurons 214A-214N of the second layer 212-2 is the value of the weights dotted with the output of the previous neurons, as shown in Equation (8) below:

$${p}_{j} = {\sum }_{n = 1}^{j} {w}_{ji} {y}_{i} \qquad ( 8 )$$

In Equation (8) above, wⱼᵢ represents the weight connecting neuron i to neuron j and yᵢ represents the output of the activation function for the i′th neuron (e.g., neurons in the previous layer). The preactivation value pⱼ for the j′th neuron is then used as the input to the activation function for that neuron e.g., φ(pⱼ).

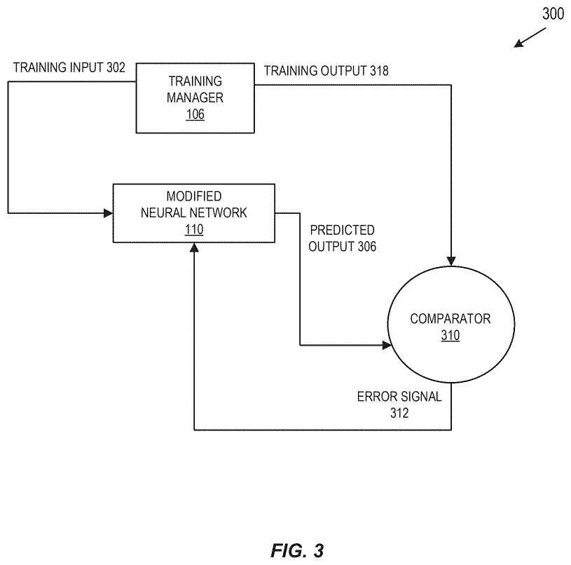

FIG. 3 illustrates an example method for training a neural network model using supervised learning, in accordance with some embodiments of the present disclosure. Supervised learning is a method of training a machine learning model given input-output pairs. An input-output pair (e.g., training input 302 and corresponding training output 318) is an input with an associated output (e.g., an expected output, a labeled output, a ground truth). The neural network trained using supervised learning is the modified neural network 110 (which was obtained when the nonlinearity manager 104 substituted the nonlinear portion of the trained neural network 120 with the dynamic nonlinear portion). Training the modified neural network 110 via the training manager 106 produces the sparse trained neural network 122.

In example 300, the training manager 106 provides the training input 302 to the modified neural network 110. The modified neural network 110 predicts output 306 by applying neurons in layers of the modified neural network 110 to the training input 302. Both the dynamic nonlinear portion of the neurons (such as neurons 204A-204N and 214A-214N) and the weights (such as weights 210-213) of the modified neural network 110 are adjusted based on an error determined by comparing the training output 318 to the predicted output 306. For example, the comparator 310 compares the predicted output 306 to the training output 318 to determine an amount of error or a loss between the predicted output 306 and the training output 318. As shown in Equation (9) below, the loss L used to train the modified neural network 110 can be a combination of losses.

$$L = {L}_{task} + {L}_{sparse} \qquad ( 9 )$$

The loss L used to adjust the dynamic nonlinear portion of the neurons and the weights of the modified neural network 110 includes a first loss such as a loss associated with performing the target task (e.g., Lₜₐₛₖ).

The sparse trained neural network 122 can be used to perform a natural language understanding task. For instance, the sparse trained neural network 122 is a transformer model. Transformers are large language models that are trained to predict a next word in a block of text using an abundance of training data to tune billions of hyperparameters of the transformer. In operation, transformers track relationships in sequential data by receiving tokens (e.g., words in a sentence) and predicting a next token (or sequence of tokens).

Accordingly, the training data that may be used to train the modified neural network 110 can include natural language text. For instance, the training input 302 can include a question and the training output 318 is an answer to the question. In some embodiments, the input-output pair (e.g., training input 302 and corresponding training output 318) is domain-specific. A domain can include a particular technology field, service field, product, and the like. Domain-specific data may include domain-specific vocabulary, domain-specific style (e.g., the use of acronyms, casual style, conservative style, professional style), and/or domain-specific formatting. The characteristics of domain-specific data distinguish such data from other domains that may not have the same vocabulary, style preferences, and/or formatting preferences. For example, the questions asked, the answers provided, the vocabulary, and the tone of a first domain (e.g., a medical domain) can be different from the questions asked, the answers provided, the vocabulary, and the tone of the second domain (e.g., a hospitality domain).

The comparator 310 can compare the predicted output 306 (e.g., a generated natural language domain-specific answer to the natural language domain-specific question used as training input 302) to the training output 318 (e.g., the actual natural language domain-specific answer to the natural language domain-specific question used as training input 302) using any natural language processing metric. For example, the comparator 310 can evaluate the generated natural language domain-specific answer to the natural language domain-specific question used as training input 302 by calculating a next token prediction loss. Mathematically, the next token prediction loss is computed using a loss function such as the cross-entropy loss. Accordingly, part of the error signal 213 can be the Lₜₐₛₖ loss determined using the cross-entropy loss (or other differentiable similarity metric).

The loss Z used to adjust the dynamic nonlinear portion of the neurons and the weights of the modified neural network 110 includes a second loss such as a loss associated with achieving the target sparsity (e.g., Lsparse). Example loss functions that can be used to minimize the number of active neurons is the mean absolute loss or the hinge loss, represented in Equation (10) below:

$${L}_{sparse ( c , \hat{k} )} = \vert c - \hat{k} \vert or \qquad ( 10 )$$

$${L}_{sparse ( c , \hat{k} )} = max ( 0 , c - \hat{k} )$$

$$Where$$

$$c = {\sum }_{i} tanh ( 4 * \vert osXLU ( {x}_{i} ) \vert )$$

In Equation (10), \hat{k} represents the target number of entries zeroed (e.g., the number of neurons that are inactive), and c represents a soft count of the number of nonzero activations (e.g., the neurons that are turned on in the modified neural network 110). The soft count c is used to mimic a count of the number of active neurons using a differentiable function.

The error signal 312 is used to adjust the weights in the modified neural network 110 such that the modified neural network 110 iteratively converges, e.g., changes (or learns) over time. The weighting coefficients of the modified neural network 110 are tuned to reduce the amount of error thereby minimizing the differences between (or otherwise converging) the predicted output 306 and the training output 318. Similarly, the number of nonzero activations is tuned to reduce the amount of error, thereby minimizing the loss L. The modified neural network 110 may be trained by the training manager 106 until the error determined at the comparator 310 is within a certain threshold, or a threshold number of batches, epochs, or iterations have been reached.

The modified neural network 110 may be trained using a backpropagation algorithm, for instance. The backpropagation algorithm operates by propagating the error signal 312 through each of the algorithmic weights of the modified neural network 110 such that the algorithmic weights and dynamic nonlinear portions adapt based on the amount of error. The error signal 312 may be calculated at each iteration (e.g., each pair of training inputs 302 and associated training outputs 318), batch, and/or epoch.

The adjustment of the weights during training facilitates the modified neural network's 110 ability to learn how to perform the target task. Similarly, the adjustment of the activations of neurons of the modified neural network facilitates the modified neural network 110 in becoming a sparse neural network. In operation, the modified neural network iteratively becomes sparse and trained over a number of training iterations.

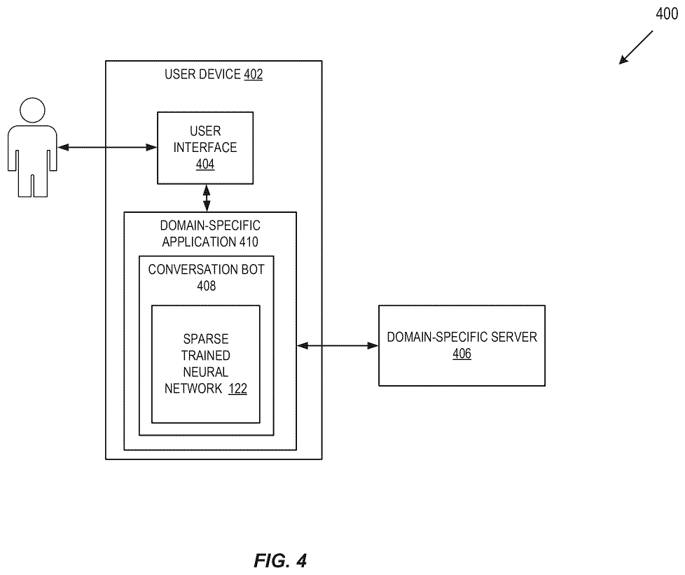

FIG. 4 illustrates an example deployment of a sparse machine learning model, in accordance with one or more embodiments. The sparsification system 100 makes the sparse trained neural network 122 sparse with respect to the trained neural network 120 by virtue of targeting a number of neurons to turn off.

Example 400 illustrates a user using a user device 402. The user device 402 is a computing device such as a mobile computing device (e.g., a laptop, a mobile phone) with limited computing resources. For example, the computing resources of user device 402 (e.g., power and/or memory) are limited by the size of the user device (e.g., a handheld device) or a battery of the user device, for instance. The user interface 404 is a portion of the user device 402 that presents information to the user such as images, natural language, video, and the like. For example, the user interface 404 can include a graphical display used to provide information to the user. The user interface 404 is also configured to receive information from a user such as natural language, audio, images, and the like.

The user device 402 includes domain-specific application 410, which can be one or more applications accessible by the user device 402. In some embodiments, domain-specific application 410 is downloaded and installed on user device 402. In other embodiments, domain-specific application 410 is accessed by the user device 402 via a web browser, for instance. The domain-specific application 410 can offer the user one or more domain-specific services. Non-limiting examples of domain-specific services can include access to a doctor's office (e., scheduling a doctor's appointment) and access to hospitality services (e.g., reserving a hotel room, making a dinner reservation), for instance. For example, a first domain-specific application enables a user to make a hostel reservation, a second domain-specific application enables a user to schedule a doctor's appointment, and the like.

The server hosting the domain-specific application 410 is the domain-specific server 406. In some embodiments, the domain-specific application 410 communicates with the domain-specific server 406 in furtherance of performance of a service. For example, an Application Programming Interface (API) of the domain-specific application 410 is used to request information from the domain-specific server 406. An API refers to an interface or communication protocol in a predefined format between a client and a server, for instance. In response to receiving an API call, an action is initiated and generally a response is communicated. For example, responsive to receiving a query from the domain-specific application 410, the domain-specific server 406 retrieves information associated with the user and communicates the user information to the domain-specific application 410. For example, the domain-specific server 406 retrieves information related to the user's scheduled doctor's appointment. The retrieved information can be displayed to the user via user interface 404 and/or provided to the sparse trained neural network 122.

In some embodiments, a user communicates with the domain-specific server 406 in a conversational format. For example, the user can input natural language text to the user interface 404 (e.g., a request to make a hotel reservation) and receive a natural language response via the user interface 404 (e.g., confirmation of a reserved hotel room). The conversational format of the communication between the user and the domain-specific application 410 and/or domain-specific server 406 is enabled using a conversation bot 408.

In some embodiments, the conversation bot 408 is an automated agent of the domain-specific server 406 (e.g., a chat bot such as a large language model) executed on the user device 402. In operation, the conversation bot 408 includes the sparse trained neural network 122. The sparse trained neural network 122 is configured to generate responses to user queries (e.g., generate a natural language response to a user input) according to the particular domain. For example, given the above example where the first domain enables a user to make a hotel reservation, the sparse trained neural network 122 generates responses to user queries related to hotel booking.

As shown in example 400, the sparse trained neural network 122 is executed at the user device 402, which can reduce latency associated with the user receiving a response from the conversation bot 408. The sparse trained neural network 122 can be executed at the user device 402 to produce domain-specific responses to user queries because of deactivated neurons that conserve computing resources associated with performing a task (e.g., generating the domain-specific responses to user queries). As a result, the operations of the sparse trained neural network 122 consume fewer resources (e.g., power, bandwidth, memory) than other non-sparse machine learning models (such as trained neural network 120), while still generating responses that are in-domain (e.g., related to hotel booking) and relevant given the user query entered into the user interface 404. In other words, the sparse trained neural network 122 is capable of being executed on a low-resource device such as user device 402 as a result of the target number of deactivated neurons that reduce the number of executed computing resources (e.g., power, memory, bandwidth) associated with performing a task (e.g., generating an in-domain response to a user query). Further, the sparse trained neural network 122 can perform domain-specific tasks (e.g., generate responses to user queries) that meet or exceed a threshold accuracy. For example, the sparse trained neural network 122 can perform natural language understanding tasks at least at the same accuracy as the accuracy of the trained neural network 120 in performing natural language understanding tasks (e.g., generating responses to user queries in a conversational format).

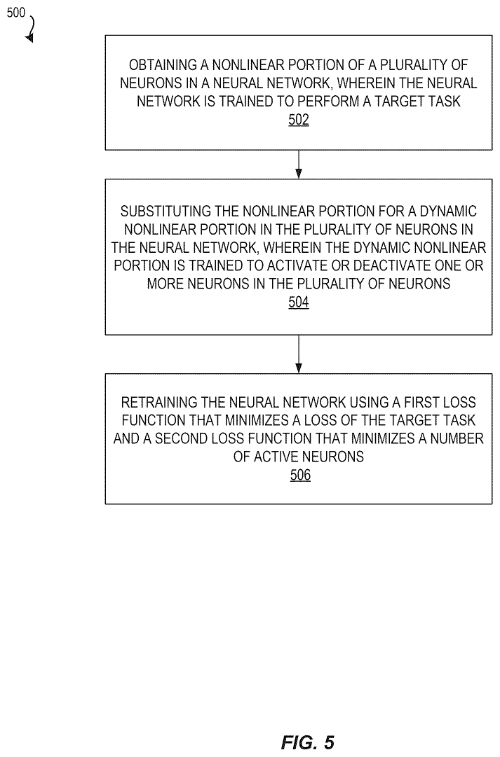

FIGS. 1-4 provide a number of embodiments and components configured to perform such embodiments that allow for training a target activation sparsity in a neural network. FIG. 5 illustrates a flowchart of an example method of training a target activation sparsity in a neural network, in accordance with one or more embodiments. It should be appreciated that FIG. 5 may be performed with additional or fewer steps than those indicated in FIG. 5. Moreover, the order of the steps indicated in FIG. 5 may be rearranged without changing the scope of FIG. 5.

FIG. 5 illustrates a flowchart 500 of a series of acts in a method of training a target activation sparsity in a neural network, in accordance with one or more embodiments. In one or more embodiments, the flowchart 500 is performed in a digital medium environment that includes the sparsification system 100.

As illustrated in FIG. 5, the method 500 includes an act 502 of obtaining a nonlinear portion of a plurality of neurons in a neural network. The neural network is trained to perform a target task. For example, the target task can be a classification task, a natural language understanding task (e.g., text summarization, question and answer), an image processing task, and the like. Activation functions are nonlinear functions that map the input of a neuron in a neural network to an output. The nonlinear mapping enables the neural network to capture complex patterns of the input of the neuron. In operation, the nonlinear mapping represents the strength of the neuron with respect to the input. There is a probability distribution associated with the set of values output by the activation function. For example, there is a likelihood of each output that can be determined using the activation function such that a probability distribution of preactivations is created (e.g., a preactivation distribution). In other words, the output of the neuron is a sampling of the probability distribution of the mapped preactivation input, where the preactivation input is mapped using the activation function chosen by a machine learning engineer. A nonlinear activation of a neuron (e.g., a preactivation distribution) is referred to herein as nonlinear portion of a neuron.

In some embodiments, obtaining the nonlinear portion of the plurality of neurons includes determining a statistical representation of the distribution of preactivations of one or more neurons that represent the nonlinear portion of the one or more neurons in the neural network. For example, the mean and standard deviation of the distribution of the preactivation can be computed to determine the statistical model of the nonlinear portion of one or more neurons. In some embodiments, obtaining the nonlinear portion of the plurality of neurons includes receiving, as an input, the nonlinear portion of at least one neuron in the plurality of neurons. For example, a machine learning engineer or other user can input the nonlinear portion of the at least one neuron.

As illustrated in FIG. 5, the method 500 includes an act 504 of substituting the nonlinear portion for a dynamic nonlinear portion in the plurality of neurons in the neural network. OsXLU is a family of learnable nonlinearities that exhibit a specified or learnable level of sparsity in expectation over the preactivations. In other words, osXLU is used to turn off a target number of neurons of the neural network. The dynamic nonlinear portion is trained to activate or deactivate one or more neurons in plurality of neurons. That is, only the neurons with the dynamic nonlinear portion can be deactivated or activated as a result of training.

Specifically, OsXLU is trained such that a number k of neurons is set to non-zero on average. The k neurons that are activated are the k most relevant neurons (e.g., the top k neurons, based on the order statistic of the underlying nonlinear portion). Order statistics is the arrangement of the values in order of magnitude. For example, given a nonlinear portion with n samples in the preactivation distribution, the (n−k)^{th} order statistic is the nonlinear portion X(n−k) which represents the (n−k)^{th} smallest value of the n samples from the nonlinear portion. Substituting osXLU in one or more neurons of the trained neural network is used to obtain the probability of any entry x of the preactivation distribution being the top-k largest activation. In other words, neurons can be ranked according to the ordered activation such that top-k neurons corresponding to the top-k activations are activated. Accordingly, neurons associated with activations that are not the top-k activations are deactivated by zeroing entries of the neuron vector.

As illustrated in FIG. 5, the method 500 includes an act 506 of retraining the neural network using a first loss function that minimizes a loss of the target task and a second loss function that minimizes a number of active neurons. The neural network with the substituted dynamic nonlinear portion in a plurality of neurons in the neural network is trained by balancing a sparsification loss and a task loss. The sparsification loss is used to minimize the active neurons of the plurality of neurons to a target sparsity (e.g., a target number of inactive neurons). In operation, during training, the number of inactive neurons is iteratively minimized until the number of inactive neurons reaches the target number of inactive neurons. The task loss is used to minimize the loss between the expected training output and the output generated by the neural network. As a result, the sparse trained neural network's performance of a target task meets or exceeds a threshold performance set by the trained neural network 120 in performing the target task.

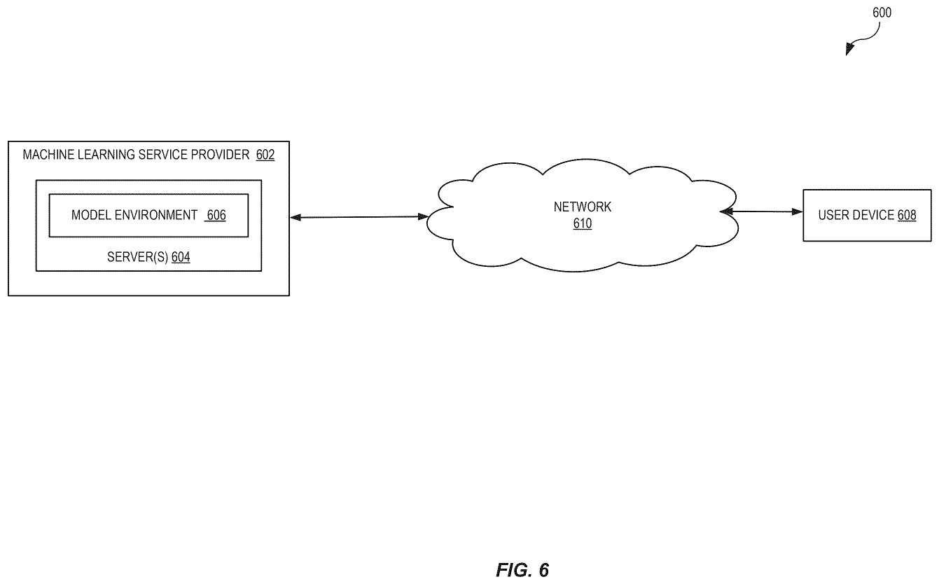

FIG. 6 illustrates a schematic diagram of an environment in which the sparsification system can operate in accordance with one or more embodiments. As shown, the environment 600 includes a machine learning service provider 602 communicating with a user device 608 via a network 610. It should be appreciated that while the user device 608 is shown communicating with the machine learning service provider 602 via network 610, the user device 608 may also communicate directly with the machine learning service provider 602. The communication between the user device 608 and the machine learning service provider 602 via network 610 may be any communication such as wireless communication and/or wired communication. In an example implementation, the machine learning service provider 602 may host a machine learning system on a server 604 using the model environment 606 and receive data from one or more user device(s) 608 via network 610.

The machine learning service provider 602 may be a service provider configured to perform one or more tasks. The machine learning service provider 602 includes one or more server(s) 604 each including a model environment 606. Each of the servers may be specialized to perform a given task of the machine learning service provider 602. Accordingly, each server 604 has a unique model environment 606 that facilitates the operation of the server. The model environment 606 may include any data necessary to perform the operations of the specific server 604 (e.g., trained machine learning models, training data, machine learning libraries, machine learning functions, etc.). In other configurations, a single server may be configured to perform multiple tasks of the machine learning service provider 602. That is, the server 604 may include multiple model environments 606.

The user device 608 may be any computing device configured to communicate data to the machine learning service provider 602. In some implementations, the user device 608 may capture or otherwise collect such data (e.g., using a camera, a microphone, some combination, or other sensor).

To illustrate, data from one or more user device(s) 608 (e.g., an interaction with an application executing the sparsification system 100) may be fed to server 604 via network 610. Upon receiving the data, such as a request to sparsify a machine learning model, the server 604 can execute the model environment 606 to execute the sparsification system 100. The sparsification system 100 performs the methods and processes described herein to train a target activation sparsity in a neural network.

In some embodiments, the data obtained by the server 604 includes a user-configurable parameter that represents the target activation sparsity in the neural network (e.g., the number of inactive neurons in the neural network). In some embodiments, the functions of the machine learning service provider 602 may be implemented via a user device 608. Additionally or alternatively, the functions of the user device 608 may be implemented via the machine learning service provider 602. The functions of the user device 608 and/or machine learning service provider 602 may be implemented in hardware, software, or both. For example, the user device 608 and/or machine learning service provider 602 may include instructions stored on a computer-readable storage medium and executable by processors of the user device 608 and/or machine learning service provider 602. Computer executable instructions may include instructions that cause one or more processors to perform one or more functions. The computer executable instructions may be stored in any computer-readable media accessible by one or more processors of the machine learning service provider 602 and/or the user device 608. In some embodiments, one or more portions of functions of the user device 608 and/or machine learning service provider 602 may be implemented in hardware, software, or both.

While one user device 608 is shown, it should be appreciated that multiple user devices 608 may communicate with the machine learning service provider 602 via network 610. Additionally or alternatively, multiple user devices 608 may communicate with each other (e.g., without communicating with machine learning service provider 602). Moreover, while one machine learning service provider 602 is shown, it should be appreciated that multiple machine learning service providers 602 may communicate with one or more user devices 608. Similarly, multiple machine learning service providers 602 may communicate with each other (e.g., without communicating with the user device 608).

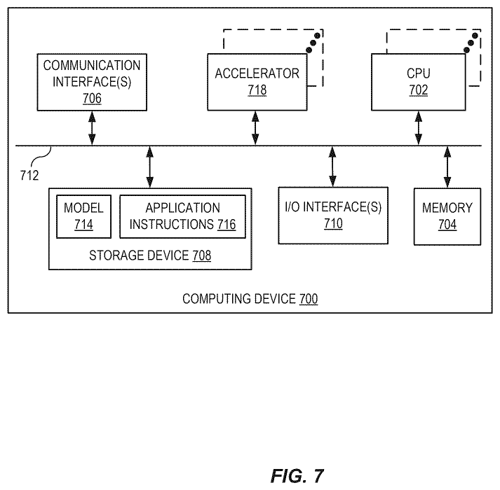

FIG. 7 illustrates a block diagram of an example computing device, in accordance with one or more embodiments. One or more computing devices such as the computing device 700 may implement one or more portions of the sparsification system 100. As shown in FIG. 7, the computing device can comprise one or more central processing units (CPUs) 702, memory 704, one or more communication interfaces 706, a storage device 708, one or more I/O interfaces 710 and one or more accelerators 718. It should be appreciated that the computing device 700 can include different components than those shown in FIG. 7.

In particular embodiments, CPU(s) 702 include hardware and/or software for executing instructions. Similarly, accelerator(s) 718 include hardware and/or software for executing instructions. In some embodiments, accelerator(s) 718 include one or more graphics processing units (GPUs). In general, the accelerator(s) 718 and CPU(s) 702 fetch data from the storage device 708 and/or memory 704. For example, the accelerator(s) 718 and CPU(s) 702 may fetch instructions from the storage device 708 and/or memory 704 and execute one or more functions identified by the instructions. The CPU(s) 702 and/or accelerator(s) 718 execute the instructions to perform the one or more processes as described herein. For example, CPU 702 may receive instructions from memory 704 (e.g., a non-transitory computer readable medium) and execute those instructions, resulting in one or more processes described herein.

The storage device 708 and/or memory 704 may include non-transitory computer readable memory such as non-volatile and/or non-volatile memory (e.g., RAM, ROM, EEPROM, CD ROM, SSDs, flash memory). The storage device 708 and/or memory 704 may be configured to store different types of data fetched by the CPU 702 and/or accelerator 718. For example, the memory 704 may include instructions directed to the functional operation of the computing device 700. Moreover, the storage device 708 may include application instructions 716 and/or models 714 directed to the applicational use of the computing device 700. For example, the model 714 may include one or more components of the sparsification system 100 as described herein. The application instructions 716 may contain instructions necessary to perform the functions of one or more components of the sparsification system 100.

The computing device 700 can further include one or more communication interfaces 706. A communication interface 706 can include hardware, software, or both configured to facilitate external communication with one or more external computing devices. The external communication with one or more external computing devices may be wireless communication and/or wired communication. The communication interface 706 may be configured to facilitate such wired/wireless communication.

The bus 712 can facilitate internal communication of the computing device 700 and may comprise hardware, software, or both, coupling components of computing device 700 to each other.

The computing device 700 also includes one or more input or output (“I/O”) interfaces 710. The I/O interface 710 is configured to receive inputs/outputs. In an example implementation, the I/O interface 710 may receive user inputs (e.g., audio data, text data, etc.). Additionally or alternatively, the I/O interface 710 may receive sensor inputs (e.g., camera images, video frames, etc.). The I/O interface 710 may be configured to output data (e.g., training information such as a number of training iterations, the training error including the task loss and the sparsity loss) to one or more other computing devices.

Various embodiments have been described and illustrated. The descriptions and illustrations herein are not to be construed as limiting. Alternative embodiments may exist without departing from the scope of the embodiments described and illustrated herein.

Disjunctive language such as “at least one of A, B, or C” is not intended to imply that a given embodiment requires at least one of A, at least one of B, or at least one or C. Instead, it is intended to be understood to mean either A, B, or C, or any combination thereof.

What is claimed is:

1. A method comprising:
obtaining a nonlinear portion of a plurality of neurons in a neural network, wherein the neural network is trained to perform a target task;
substituting the nonlinear portion for a dynamic nonlinear portion in the plurality of neurons in the neural network, wherein the dynamic nonlinear portion is trained to activate or deactivate one or more neurons in the plurality of neurons; and
retraining the neural network using a first loss function that minimizes a loss of the target task and a second loss function that minimizes a number of active neurons.

2. The method of claim 1, wherein the nonlinear portion of a neuron of the plurality of neurons is a preactivation distribution of the neuron.

3. The method of claim 2, wherein the preactivation distribution is based on a nonlinear activation function of the neuron of the plurality of neurons.

4. The method of claim 2, wherein the dynamic nonlinear portion is trained to activate or deactivate one or more neurons in the neural network further comprises:
ordering samples of the preactivation distribution of the one or more neurons; and
selecting a number of neurons to activate responsive to a top number of the one or more neurons.

5. The method of claim 1, wherein obtaining the nonlinear portion of the plurality of neurons in the neural network further comprises:
computing a mean and a standard deviation of a preactivation distribution of a neuron of the plurality of neurons; and
determining a statistical model using the mean and the standard deviation.

6. The method of claim 1, wherein the retrained neural network is a sparse neural network having a target number of inactive neurons.

7. The method of claim 1, further comprising:
receiving a number of neurons in the neural network to be inactive, wherein the second loss function that minimizes the number of active neurons is based on the number of neurons in the neural network to be inactive.

8. A non-transitory computer-readable medium storing executable instructions, which when executed by a processing device, cause the processing device to perform operations comprising:
obtaining a nonlinear portion of a plurality of neurons in a neural network, wherein the neural network is trained to perform a target task;
substituting the nonlinear portion for a dynamic nonlinear portion in the plurality of neurons in the neural network, wherein the dynamic nonlinear portion is trained to activate or deactivate one or more neurons in the plurality of neurons; and
retraining the neural network using a first loss function that minimizes a loss of the target task and a second loss function that minimizes a number of active neurons.

9. The non-transitory computer-readable medium of claim 8, wherein the nonlinear portion of a neuron of the plurality of neurons is a preactivation distribution of the neuron.

10. The non-transitory computer-readable medium of claim 9, wherein the preactivation distribution is based on a nonlinear activation function of the neuron of the plurality of neurons.

11. The non-transitory computer-readable medium of claim 9, wherein the dynamic nonlinear portion is trained to activate or deactivate one or more neurons in the neural network further comprises operations including:
ordering samples of the preactivation distribution of the one or more neurons; and
selecting a number of neurons to activate responsive to a top number of the one or more neurons.

12. The non-transitory computer-readable medium of claim 8, wherein obtaining the nonlinear portion of the plurality of neurons in the neural network further comprises operations including:
computing a mean and a standard deviation of a preactivation distribution of a neuron of the plurality of neurons; and
determining a statistical model using the mean and the standard deviation.

13. The non-transitory computer-readable medium of claim 8, wherein the retrained neural network is a sparse neural network having a target number of inactive neurons.

14. The non-transitory computer-readable medium of claim 8, wherein the operations further comprise:
receiving a number of neurons in the neural network to be inactive, wherein the second loss function that minimizes the number of active neurons is based on the number of neurons in the neural network to be inactive.

15. A system comprising:
a memory component; and
a processing device coupled to the memory component, the processing device to perform operations comprising:
obtaining a nonlinear portion of a plurality of neurons in a neural network, wherein the neural network is trained to perform a target task;
substituting the nonlinear portion for a dynamic nonlinear portion in the plurality of neurons in the neural network, wherein the dynamic nonlinear portion is trained to activate or deactivate one or more neurons in the plurality of neurons; and
retraining the neural network using a first loss function that minimizes a loss of the target task and a second loss function that minimizes a number of active neurons.

16. The system of claim 15, wherein the nonlinear portion of a neuron of the plurality of neurons is a preactivation distribution of the neuron.

17. The system of claim 16, wherein the dynamic nonlinear portion is trained to activate or deactivate one or more neurons in the neural network further comprises operations including:
ordering samples of the preactivation distribution of the one or more neurons; and
selecting a number of neurons to activate responsive to a top number of the one or more neurons.

18. The system of claim 15, wherein obtaining the nonlinear portion of the plurality of neurons in the neural network further comprises operations including:
computing a mean and a standard deviation of a preactivation distribution of a neuron of the plurality of neurons; and
determining a statistical model using the mean and the standard deviation.

19. The system of claim 15, wherein the retrained neural network is a sparse neural network having a target number of inactive neurons.

20. The system of claim 15, wherein the operations further comprise:
receiving a number of neurons in the neural network to be inactive, wherein the second loss function that minimizes the number of active neurons is based on the number of neurons in the neural network to be inactive.
